(19) United States
(12) Patent Application Publication
(10) Pub. No.: US 2013/0168184 A1
(43) Pub. Date: Jul. 4, 2013

(54) Support Systems and Related Methods for Maintaining Building Exteriors

(71) Applicant: The Ziproller Company, LLC, Stockton, CA (US)

(72) Inventor: Jay Edward Tyler, Medford, OR (US)

(73) Assignee: THE ZIPROLLER COMPANY, LLC, Stockton, CA (US)

(21) Appl. No.: 13/707,544

(22) Filed: Dec. 6, 2012

Related U.S. Application Data
(60) Provisional application No. 61/568,350, filed on Dec. 8, 2011.

(51) Int. Cl. B66F 11/00

(52) U.S. Cl. CPC B66F 11/00
USPC 182/3; 182/12

(57) ABSTRACT

The present invention relates to system and methods for exterior building maintenance. In one embodiment, a mobile support system for supporting a suspended user includes a top supporter, one or more rope support points, an inner parapet guide and an outer parapet guide. The top supporter includes a rolling assembly for travelling along a top surface of a rooftop parapet. The top supporter also includes a support point for a rope to securely suspend the user adjacent to the building exterior. The inner parapet guide, coupled to the top supporter, guides and stabilizes the top supporter by travelling along a vertical inner surface of the rooftop parapet. Similarly, the outer parapet guide, also coupled to the top supporter, guides and stabilizes the top supporter by travelling along an opposing outer surface of the rooftop parapet.

### CROSS REFERENCE TO RELATED APPLICATIONS

This non-provisional application claims the benefit of provisional application No. 61/568,350 filed on Dec. 8, 2011, entitled “Support Systems and Related Methods for Maintaining Building Exteriors”, which application is incorporated herein in its entirety by this reference.

### BACKGROUND

The present invention relates to support systems and related methods for maintaining the exteriors of buildings.

Almost all buildings are constantly in need of maintenance, ranging from the regular cleaning of windows to more involved tasks such as painting and repairing the exterior walls. Such maintenance is necessary for preserving both the short term value and long term value of these buildings.

There are several known solutions for safely suspending users outside building exteriors. One costly solution is the use of a gondola-like building maintenance unit (BMU) with a swinging stage suspended by two ropes coupled to motors at both ends of the stage. The typical stage can support one or more users and their equipment. Other names for similar BMU equipment include temporary suspended platforms. BMU systems can cost upwards of several tens of thousands of dollars.

A less costly solution is a weighted roof rig with an outreach bar. The weighted roof rig is basically miniature wheeled vehicles that look like a tow truck. The outreach bar hangs over the edge of a building roof to support the individual user in a safety Bosun's chair (also known as a boatswain's chair) or a climbing harness. Although cheaper than BMUs, a second person is required on the rooftop to operate the roof rig which increases the overhead costs.

It is therefore apparent that an urgent need exists for simpler and more elegant systems to safely suspend users on building exteriors. Such improved systems and methods will allow users to more efficiently and cost-effectively maintain buildings.

### SUMMARY

To achieve the foregoing and in accordance with the present invention, systems and methods for maintaining building exteriors, especially exteriors of high rise buildings, are provided.

In one embodiment, a mobile support system for supporting or suspending a user or an exterior building maintenance device includes a top supporter, at least one rope support point, an inner parapet guide, and an outer parapet guide. Such a mobile support system is useful in association with a Bosun's chair or harness, a rope anchoring system and a rooftop parapet of a building.

The top supporter includes a stable rolling assembly configured to travel along a substantially horizontal top surface of a rooftop parapet of a building. In this embodiment, the top supporter also includes at least one support point configured to support a rope for securely supporting or suspending a user or an exterior building maintenance device adjacent to an exterior surface of the building. The rope is secured to a rope anchoring system located on the rooftop of the building.

The inner parapet guide is coupled to an inner portion of the top supporter and configured to guide and stabilize the top supporter by travelling along a substantially vertical inner surface of the rooftop parapet. Similarly, the outer parapet guide coupled to an outer portion of the top supporter and configured to guide and stabilize the top supporter by travelling along a substantially vertical opposing outer surface of the rooftop parapet.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A and 1B are side views illustrating one embodiment of a mobile support system in accordance with the present invention;

FIG. 1C is a side view showing the embodiment of FIG. 1A operatively coupled to a rooftop parapet;

FIGS. 2A and 2B are front and top views, respectively, showing an exemplary top supporter for the embodiment of FIG. 1A;

FIG. 3 illustrates another embodiment of a mobile support system that provides sufficient clearance from rooftop crown molding; and

FIG. 4 shows a perspective view of the embodiment of FIG. 1A.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

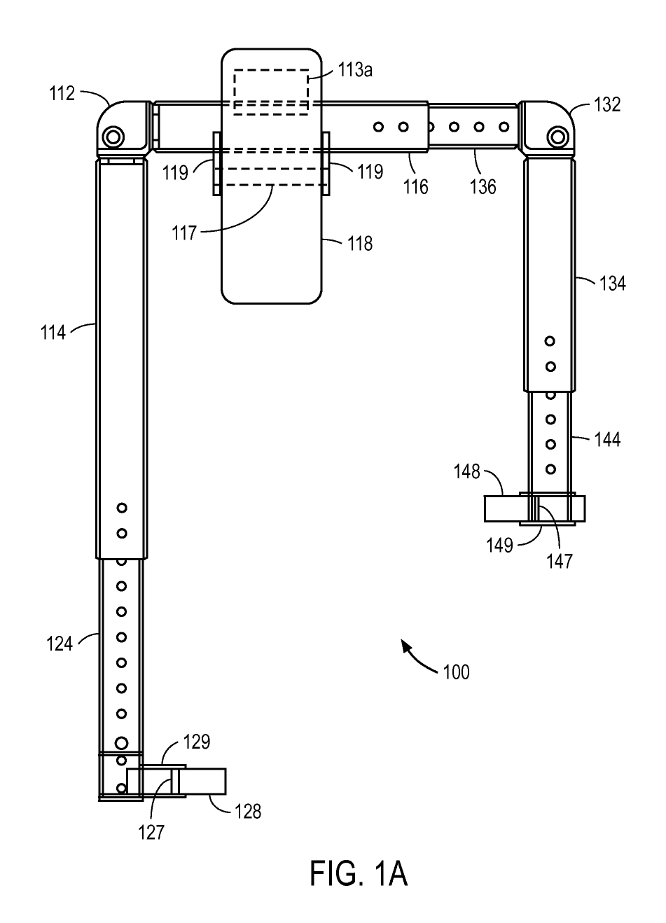

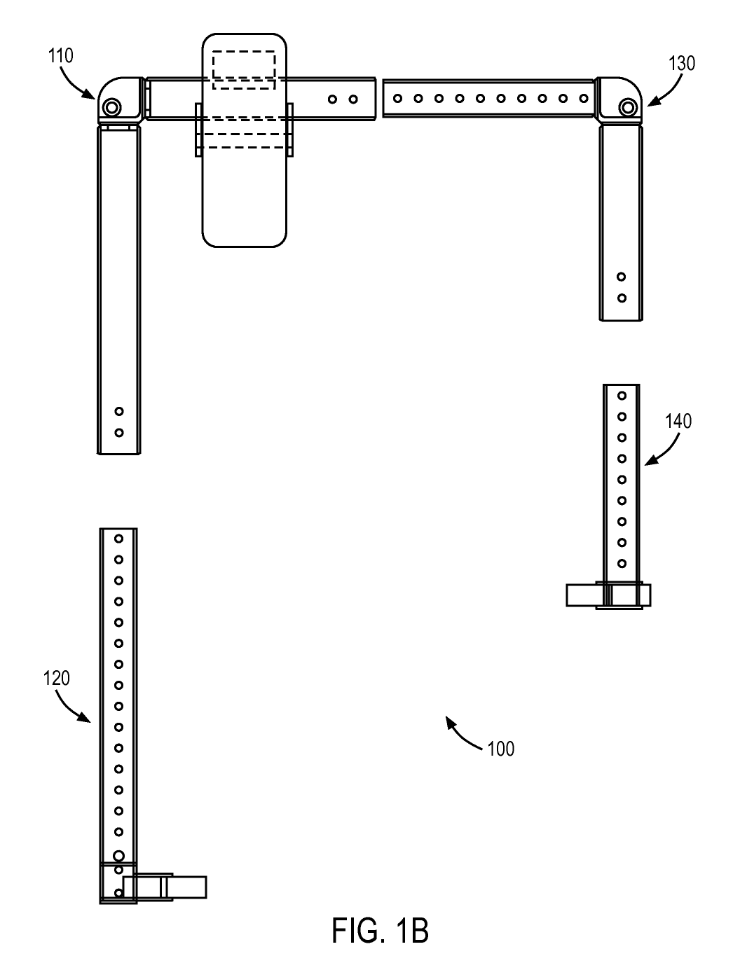

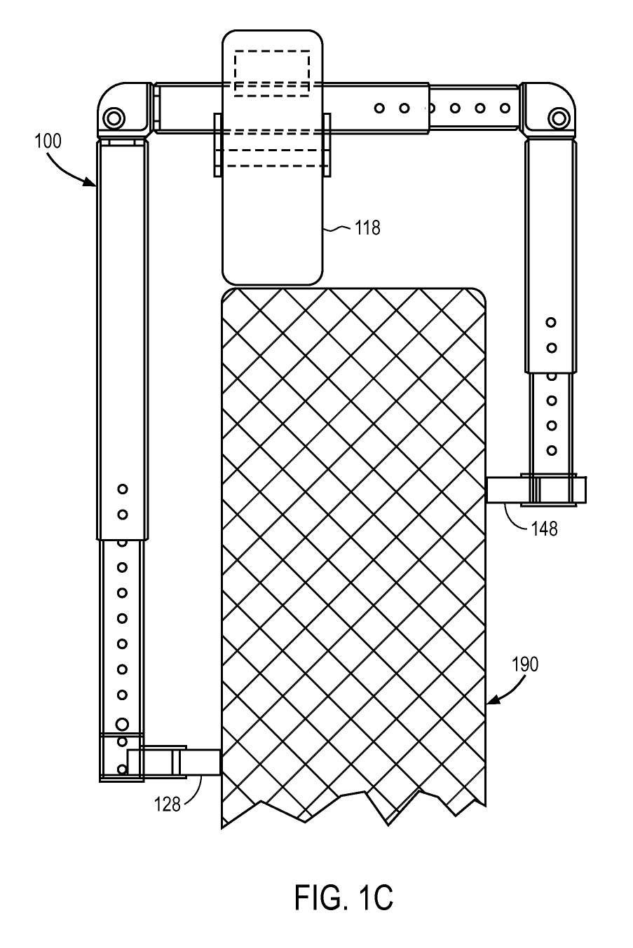

The present invention relates to systems and methods for maintenance of building exteriors, especially exteriors of high rise buildings. To facilitate discussion, FIGS. 1A and 1B are assembled and exploded side views, respectively, illustrating one embodiment of a mobile support system 100 having a top supporter 110, and an outer parapet guide 120, and a two-piece inner parapet guide 130, 140.

Top supporter 110 and parapet guides 120, 130, 140 can be secured to each other by retaining pins, e.g., a quick-release steel hitch pin 450. Suitable materials for manufacturing support system 100 include metallic alloys such as steel, titanium, magnesium and aluminum, and other non-metallic materials such as fiberglass, carbon fiber, and combinations thereof.

As discussed above, in this exemplary embodiment, mobile support system 100 comprises of four main structural components, the top supporter 110, the outer parapet guide 120, and the two-piece inner parapet guide 130, 140. However, it is also possible to construct a mobile support system using one, two, three, or five or more structural component (not shown).

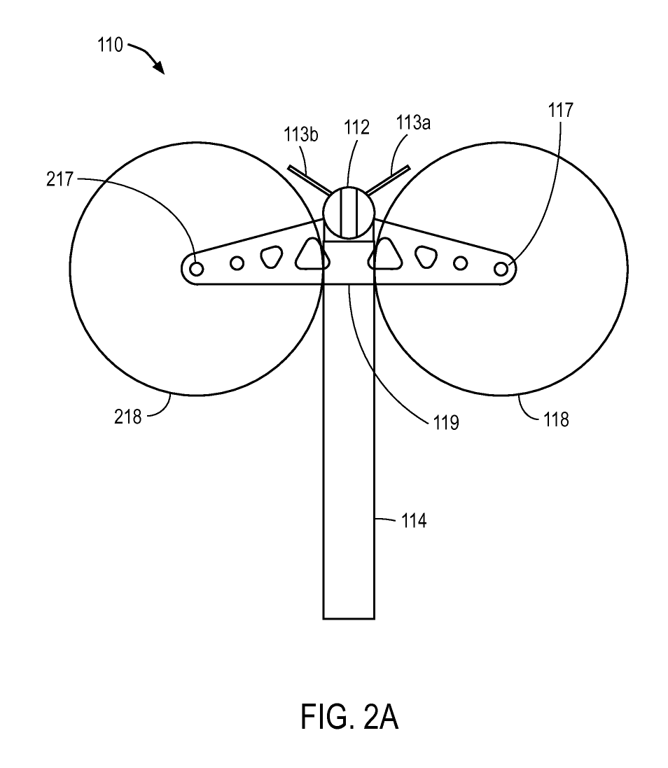

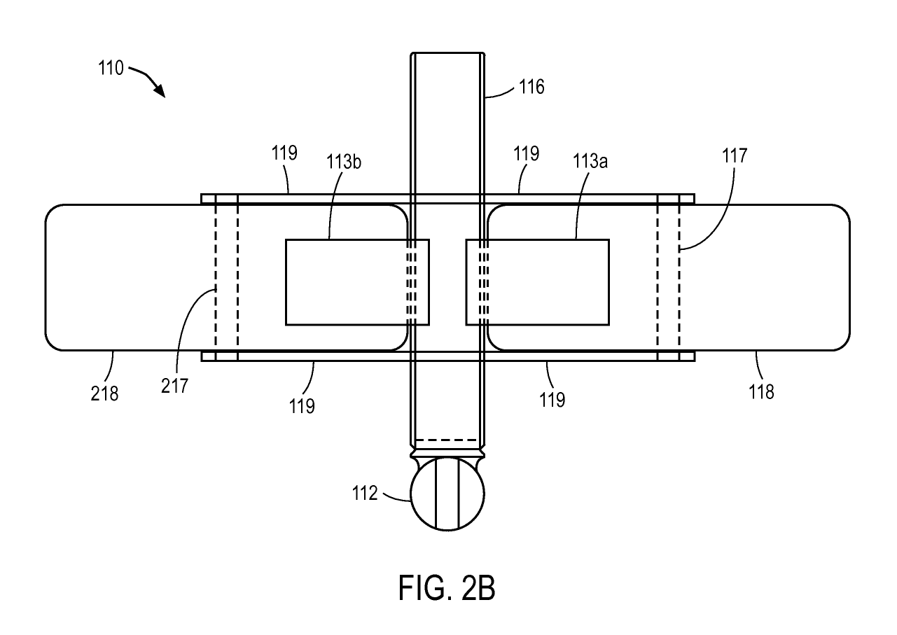

Referring also to FIGS. 2A and 2B, which are front view and top views, respectively, of an exemplary load-bearing top supporter 110 for the mobile support system 100, top supporter 110 includes an elbow 112, a lower arm 114, an upper arm 116, an axle 117, a wheel 118, and a bracket 119. Supporter 110 also includes a second wheel 218 and a second axle 217. Both axles 117 and 217 are coupled to bracket 119. Top supporter wheels 118, 218 can either be solid or pneumatic. Depending on the parapet surface, suitable materials for wheels 118, 218 include rubber and polyurethane.

In this embodiment, the top supporter 110 can also include one or more rope support points for guiding one or more ropes used to suspend a user over the rooftop parapet 190 and along the exterior wall of building. Examples of rope support points include protruding rope guides such as rope guides 113a, 113b, recessed guides like grooves or channels, or through holes, or combinations thereof.

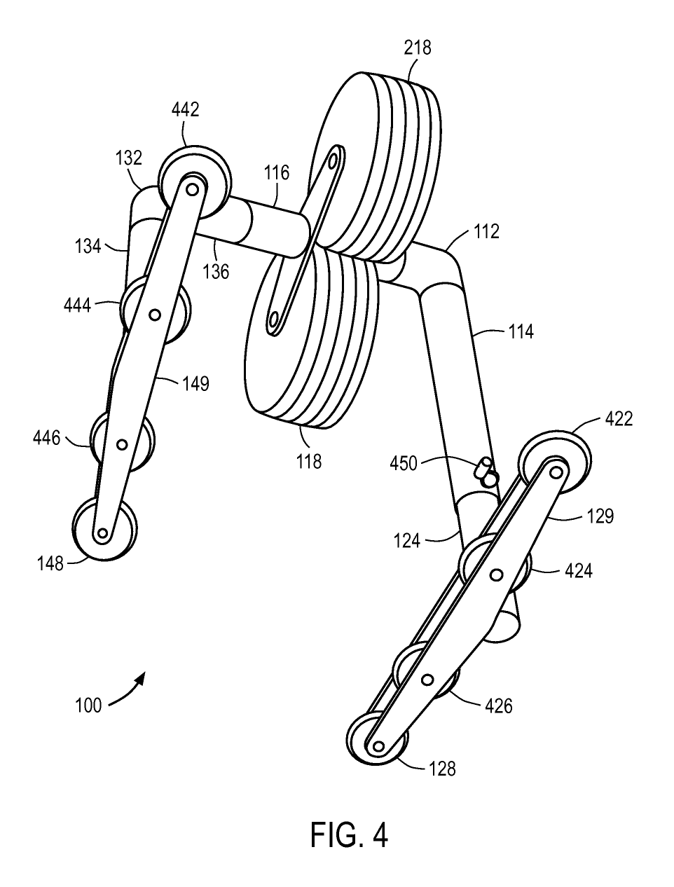

Referring back to FIGS. 1A-1C and also to the perspective view of FIG. 4, outer parapet guide 120 includes a telescoping arm 124, an axle 127, a wheel 128 and a bracket 129. In this embodiment as shown in FIG. 4, outer parapet guide 120 can include one or more additional in-line wheels 422, 424, 426, arranged in a manner similar to that of an inline roller blade, thereby increasing the stability of support system 100 when travelling on parapet 190.

In this embodiment, inner parapet guide includes two detachable components 130, 140, which in turn include a telescoping top arm 136, an elbow 132, a lower arm 134, a telescoping lower arm 144, an axle 147, a wheel 148, and a bracket 149. To enhance stability, inner parapet guide 120 can also include one or more additional in-line wheels 442, 444, 446.

Guide wheels for both outer and inner parapet guides, e.g., wheels 128, 148, can be selected to best conform to the construction and material of the parapet 190 and/or the exterior wall of the building being maintained. Accordingly, wheels 128, 148 can be made from a variety of suitable materials, such as polyurethane, rubber or nylon.

For ease of transportation, mobile support system 100 can be assembled on site, e.g., on the rooftop, and configured to fit the characteristics of the parapet of a building, by adjusting telescoping arms 124, 136, 144 relative to corresponding arms 114, 116, 134, respectively. Once configured, the support system 100 can then be lowered on top of the parapet so that top supporter wheels 118, 128 are resting securely on the substantially-horizontal top surface of the parapet, with the outer and inner parapet guides 120, 140 adjacent to the substantially vertical opposing surfaces of the parapet 190.

One end of a primary support rope is then secured to a Bosun's chair (also known as a boatswain's chair) or a climbing harness, or to a piece of building maintenance equipment. The other end of the primary rope and a secondary safety rope are secured to a rope anchoring system (not shown) located on the rooftop of the building. The ropes can then be lowered over parapet 190 using exemplary V-shaped rope guide 113a, 113b of the support system 100 to prevent the ropes from being tangled with wheels 118, 218. Mobile support system 100 can now safely and efficiently support and/or suspend the user seated in the Bosun's chair or harness, and/or support/suspend a piece of building maintenance equipment, adjacent to the building's exterior.

Rope anchoring systems with safety lines are well known to one skilled in the arts, and are well regulated by both the Federal and State laws. For example, Occupational Safety & Health Act (OSHA) Section 5(a)(1) states that an employer “shall furnish to each of his employees employment and a place of employment which are free from recognized hazards that are causing or likely to cause death or serious physical harm to his employees”, resulting in the promulgation of Federal regulations such as 29 CFR 1926.

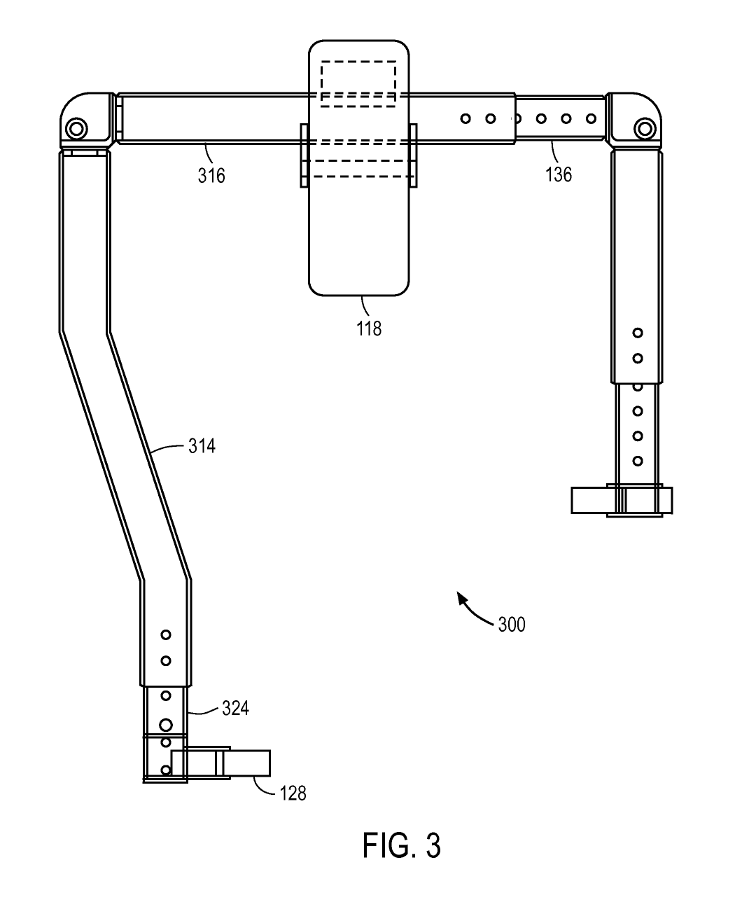

Many modifications to the above described mobile support systems are also possible. For example, as shown in FIG. 3, for compatibility with buildings having decorative crown molding along the roofline, a modified mobile support system 300 includes elongated upper arm 316 and an offset lower arm 314 that provides sufficient clearance from the crown molding as the support system 300 travels along the parapet.

This offset for lower arm of the top supporter 110 can be accomplished by introducing curve(s) or bend(s) or combinations thereof. Alternatively, instead of an offset arm, the addition of one of more telescoping joint(s) between the top supporter 110 and the outer parapet guide 120, e.g. along the horizontal axis, can also provide the necessary clearance from the crown molding.

It is also possible to install a track on the top surface of a rooftop parapet of a building, similar to a mono-rail track, thereby providing a predetermined travel path for the wheels 118, 218 of top supporter 110. Such a track should further enhance stability and hence the safety of the user or equipment.

In another embodiment, the inner parapet guide and/or the outer parapet guide may have only one wheel instead of a plurality of wheels, i.e., two wheels, three wheels, or four or more wheels.

It is also possible for one or both of the parapet guides to have multiple wheels that can articulate independently (like an automobile's independent suspension system), e.g., two separate brackets with two inline wheels in each bracket. Such an arrangement will enable the mobile support system to better cope with buildings having curved exterior walls.

Other techniques for reducing rolling friction are also possible. For example, the parapet guides may include rolling balls, operating like ball bearings, in place of rolling wheels. Alternatively, the parapet guides can have tracked rolling systems, similar to that of a construction tractor.

Many enhancements and/or additions to the above described mobile support systems are also possible. For example, one or more pulleys and/or rollers may be incorporated as rope support point(s) at strategic location(s) of the mobile support system 100, such as at the elbows 112, 132, thereby reducing wear and tear of the ropes during operation. Note that these pulley(s) and/or roller(s) can be addition(s) to or replacement(s) of rope guide(s).

Other potential enhancements of the exemplary mobile support systems of the present invention are also possible. Examples include motorization, brakes and/or shock absorbers.

Accessories for the mobile support systems are also possible. For example, an auxiliary rolling arch or arbor may be deployed between the mobile support system 100 and the rope anchoring system on the rooftop, enabling the user to clear some rooftop obstacles, such as vents or skylights, without the need for a second operator on the rooftop.

In sum, the present invention provides systems and methods for maintenance of building exteriors, especially exteriors of high rise buildings. Advantages include the ability for a single user to cost-effectively and safely suspend himself or herself while traversing the substantially vertical exterior surface of a building during maintenance, and performing a wide variety of tasks such as window cleaning, painting or repairing.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A mobile support system for supporting or suspending a user or an exterior building maintenance device, the support system useful in association with a rope anchoring system and a rooftop parapet of a building, the support system comprising:
a top supporter having a rolling assembly configured to travel along a substantially horizontal top surface of a rooftop parapet of a building;
at least one rope support point configured to support a rope for securely supporting or suspending a user or an exterior building maintenance device adjacent to an exterior surface of the building;
an inner parapet guide coupled to the top supporter and configured to guide the top supporter by travelling along a substantially vertical inner surface of the rooftop parapet; and
an outer parapet guide coupled to the top supporter and configured to guide the top supporter by travelling along a substantially vertical opposing outer surface of the rooftop parapet.

2. The mobile support system of claim 1 wherein the rolling assembly of the top supporter includes at least two wheels.

3. The mobile support system of claim 1 wherein the inner parapet guide and the outer parapet guide each includes at least one wheel.

4. The mobile support system of claim 1 wherein the inner parapet guide and the outer parapet guide each includes a plurality of inline wheels.

5. The mobile support system of claim 1 wherein the inner parapet guide or the outer parapet guide includes a plurality of wheels configured to independently articulate over a curved building exterior.

6. The mobile support system of claim 1 wherein the inner parapet guide and the outer parapet guide each includes at least one wheel made from a non-marring material configured to prevent marking or damaging the exterior surface of the building.

7. The mobile support system of claim 1 wherein the inner parapet guide and the outer parapet guide each telescopes relative to the top supporter thereby conforming to dimensions of the rooftop parapet.

8. The mobile support system of claim 1 wherein the top supporter includes an offset arm configured to provide sufficient clearance from crown molding of the parapet.

9. The mobile support system of claim 1 wherein the at least one rope support point is a rope guide.

10. The mobile support system of claim 1 wherein the at least one rope support point is coupled to the top supporter.

11. The mobile support system of claim 1 wherein the at least one rope support point is coupled to the outer parapet guide.

12. The mobile support system of claim 1 wherein the at least one rope support point is a pulley.

13. The mobile support system of claim 1 wherein the at least one rope support point is a roller.

14. The mobile support system of claim 1 wherein the user is suspended from a Bosun's chair coupled to the rope.

15. The mobile support system of claim 1 wherein the user is suspended from a harness coupled to the rope.

16. The mobile support system of claim 1 wherein the rope is secured to a rope anchoring system located on the rooftop of the building.
